(19) United States
(12) Patent Application Publication
(10) Pub. No.: US 2013/0311528 A1
(43) Pub. Date: Nov. 21, 2013

(54) COMMUNICATIONS WITH A PROXY FOR THE DEPARTED AND OTHER DEVICES AND SERVICES FOR COMMUNICAITON AND PRESENTATION IN VIRTUAL REALITY

(71) Applicant: Raanan Liebermann, North Haven, CT (US)

(72) Inventor: Raanan Liebermann, North Haven, CT (US)

(21) Appl. No.: 13/869,013

(22) Filed: Apr. 23, 2013

Related U.S. Application Data
(60) Provisional application No. 61/638,010, filed on Apr. 25, 2012.

(51) Int. Cl. G06F 17/30

(52) U.S. Cl. CPC G06F 17/30
USPC 707/899

(57) ABSTRACT

Creating a database for constructing a proxy of humans and animals, utilizing segments of appearance, voice, sound and thought process for enabling communication with, passive and active interaction with and observance of the constructed proxy, while said proxy is not available for real-time communication and other said functions.

### BACKGROUND

1. Field of the Invention

The present invention relates to a method and system for generating specific electronic proxy for humans as well as animals under certain situations. It presents one or more, either singly or in combination, such elements as video, Skype, holograms, text, voice, sound and at least one of a thought content, behavior content, expressive content and alike. It may be presented in various forms, including on demand, constructing the needed elements from existing databases, as well as those that undergo construction in session for real time creation for variety of human and animal purposes. Said purposes may be for satisfying emotional or inquisitive interest, as well service related, ranging from store attendance, to education and teaching, entertainment and performing or medical services, attendance and assistance, as well as police and military operations. Such electronic proxy may be static or dynamic. Namely, in its static form it may relate to a single occurrence in time for memorializing it or an assembly of individual memorization. As an example, it may be a cemetery for global access of generating and maintaining an Internet cemetery for at least one of a persons and pets, where in such situation both a pet owner and his or her beloved pet may be “laid to rest” and memorialized together.

2. Prior Art

Generation of specific video stream by picking and choosing discrete video clips from a database of video clips previously taken is by now known art (Liebermann et. al, now U.S. Pat. No. 7,774,194, entitled “Method and apparatus for seamless transition of voice and/or text into sign language”). Said known art is incorporated here by reference. This particular known art was created for the application of generating sign language as translation from English speech or text and then to Sign Language. There has not been to date any usage of such technology or its equivalent in text, voice, video, or holograms in the application of generating such application for a post mortem virtual communication from a person that had departed life. Neither has any of said application(s) been generated utilizing animals as either protagonist(s) or recipients of such material.

Text to speech and speech recognition technologies are already well known in the art. Also, three-dimensional holographic pictures of items and live figures are by now a known art, such as the Musion Eyeliner product. There has not been to date any usage of such technology in the post mortem application of generating a figure of a person, or an animal that had departed life, allowing virtual communication of a living entity with such a proxy.

The technology disclosed here encompasses parsing of text segments, parsing at least one of audio and speech segments, and parsing holographic segments where the segments all come from appropriate databases. It also encompasses parsing of body parts and specifically facial parts in creating facial features that change with varied situations, mimicking an authentic facial changes by the real live person according to certain prevailing situations that now appear only through the appropriate proxy image. The present invention enables incorporating with such physical embodiments also the parsing of segments of expressions and thoughts of a departed entity. It allows for a virtual communication with such a person, whereby response to a question asked by a living person can be answered by the electronic proxy utilizing segments of what the departed might have responded if he or she were alive. Such response when provided in the voice of the departed and physical appearance and mannerisms of the departed may create the illusion of a communication with the real living person. Timing and synchronization between movements and speech is part of the technical set up for the complete product in that specific embodiment. The databases are constructed according to what is known in the art that is already sufficient for a successful operating product.

### SUMMARY OF THE INVENTION

The virtual communication with a proxy described in this disclosure enables a living person to get acquainted and/or communicate with a proxy of the departed from life. Alternatively, it enables to re-live past communications with the departed from life through visual observation and/or communication with the proxy that may simulate physical appearance, simulated voice and simulated communication content based on typical thought process and mannerism of the departed from life. Said simulations may result from specific text, voice, video, or holographic articulation of a living person, including thought process of said departed person participating in said communication, as well as from another departed person creating a simulated dialog between said two parties. Virtual activities as described herein may also be relevant for animals, such as pets, whether alone or in conjunction with humans. An example of a virtual cemetery is also described with added utilities.

There are numerous applications for the electronic proxy that go beyond personal communication with a specified departed person. The present invention also relates to a utility of incorporating artificial intelligence in robotic applications. Such is the case for example when a person desires counseling from a professional that is not physically available to make eve contact with the person. It is also useful for communication of a spouse with the other spouse, whereas said other spouse is stationed in a remote location and is not available for an ad hoc communication when desired or needed. Further, there are applications for personal use such as activation for police and military applications or of a personal butler, whether such applications include visual contact or are utilized in the background, such as in the case of a personal email butler that will be discussed next.

The utility of said simulated communication content has usage in proxy of communications by email in cases where a person has not departed. Such a case is when an automated email reader and response facility examines_incoming emails where it examines each email received to determine the subject matter of the content, irrespective of the subject title. It may also add identifying content related to specific specified material by the email recipient that articulates identification of subject matter that may be of interest. Such interests may be in areas of current involvement or may not be of interest to the recipient and so marked, such as sales information that overcame any potential Spam or other blocking barriers. Further, once identified, specific content may receive automatic generated response that utilizes the personality traits of the email recipient, as well as what he or she would have answered would they have read and replied to the email. Such a proxy facility mat_enable processing a large number of incoming emails without burdening the recipient, who may just receive a few selected email pieces based on pre-established criteria. Said criteria is adhered to by examining content as performed by the proxy utility with the assistance of at least one data base(s) for accumulated pertinent information from past email activity of the user, as well as other relevant material that may be connected to it, such as documents and letter authored by said individual.

In accordance with the instant disclosure, there is described a system for generating communications with a proxy of the departed from life, by enacting at least one of a the physical appearance, voice and text with content simulating said departed person or animal, thought content or process and behavior characteristic to said person or animal that had departed from life.

There is further described various security utilities utilizing proxy figures of such entities as persons, animals or objects and utilizing characteristics commensurate with same, as described hereinabove, not necessarily of departed individuals or animals. The latter may be used for deterrent effect in residential or commercial facilities.

In accordance with the instant disclosure, there is also described a proxy utility encompassing virtual cemetery and various derivative utilities related thereto.

Other details of the Proxy generation and activation, simulating a person or animal, whether departed from life, or alive but who may be in a different location, such as a spouse of a soldier positioned away and who wishes to communicate with said soldier even if only in a proxy form, including other forms of electronic proxy, such as a virtual cemetery and related derivative utilities of the present invention, as well as other objects and advantages attendant thereto are set forth in the following detailed description and the accompanying drawings, where like reference numerals depict like elements.

### BRIEF DESCRIPTION OF THE DRAWINGS

FIG. 1 illustrates known art of creating a still hologram figure.

FIG. 2 illustrates a general description of the proxy product.

FIG. 3 illustrates the proxy product utilized in a personal as well as in business manner.

FIG. 4 illustrates coordinated hologram with automated mechanical functions.

FIG. 5 illustrates the intake analysis

FIG. 6 illustrates the personal idiosyncratic segment

FIG. 6 illustrates a Q & A session

FIG. 7 illustrates unexpected events

FIG. 8 illustrates the basic functions of holographic attendants in a particular embodiment.

FIG. 9 illustrates business proxy hologram

FIG. 10 illustrates personal email butler

FIG. 11 illustrates a proxy for security

### DETAILED DESCRIPTION OF THE PREFERRED EMBODIMENT(S)

Google is known as a glamorous search engine but its financial life comes from being an unglamorous ad-agency. The instant Proxy product is in certain parts a glamorous cutting edge technology flying on the wings of imagination, but its expected major financial life may basically be an unglamorous employment agency, and likewise an unglamorous insurance agency. Thus, like Google, our innovation has a solid and familiar, as well as time trusted financial anchor, irrespective of the technology. We will start from the personal need and a simplistic technical solution that will escalate in complexity, then bridge into the business segment.

It is human nature that survivors of a departed person wish to have the person in their lives, hear and see the person. Many times even grown up person wishes for a departed parent to be there to express happiness or sadness, let alone ask for advice; alas it is obviously not practical. The present invention provides for a proxy that enables as close as is wished for and as close as possibly practical to provide such amenities. It is divided into ascending levels of virtual reality as described below. The product is not for everyone and there would be some people who would prefer closure, yet other might find it best not to avail it to children or even adults in certain mental states. Rules for such exclusion may be built into the system for the commercialization stage.

The product is divided into six different provision forms in ascending levels of service, technology and sophistication, where the latter one is also utilized in the business segment. The first level is exemplified by a simple postal mail and emails sent out by the proxy. Namely, an automated computer program responsible for such dispatch is knowingly “masquerading” to be the real person sending the mail piece to the survivors, who may be celebrating events in their lives. The product progresses next to the level where voice of the departed is utilized either in a message or in ad hoc answers to questions posed. It I accomplished by utilizing voice samples, databases and artificial intelligence (such as neural networks and/or fuzzy logic) to create answers befitting the questions in the spirit of the departed. The next level provide interactive video where clips are segmented out of previous video intake(s) and parsed seamlessly. Finally, the product culminates with one-on-one interactive communication with a holographic image of the departed person as proxy, where both the image and the voice are that of the departed. The voice recognition engine turns the live speaker's words and phrases into text that is analyzed based on the algorithms provided by the state of the art. Answers are provided by the proxy, based on samples of thought process and speech mannerisms of the departed, in the voice of the departed that appear to be provided by the image of the departed with its own idiosyncratic body, arm movements, and facial expression. Such provision is built from a database of appropriate connecting segments (the described technology is an extension of what we termed “transitions” technology used in said translation to sign language as taught by Liebermann et al.

It would appear to the observer that indeed a discussion takes place with the departed, except that when trying to touch the real looking image of the departed that talks in the voice of the departed and has body movements and general ideas as the departed, the hand would go through air as there is no real blood and flesh person there but rather a hologram with the voice, expressive form and thought process of the departed. In one embodiment, pictures or video of the live person partaking in the session and asking the questions is also taken and analyzed in real time, enabling the departed figure to comment appropriately. For example, if the alive person rubs his or her eyes while asking a question, the holographic figure may also respond by saying: “don't rub your eyes”. Such activities add to the “authenticity” of the proxy in operation and make the session closer to reality.

The benefits are multifaceted. Besides what we have already discussed, there are persons who would like their at least one of a image, voice and appearance to be immortalized beyond their immediate families and friends. Such persons may visit an outfit of companies providing the (e.g. Proxy Rental) product and services to have their image and voice cataloged in the databases for usage in the future. In the business model they could pay for it a prescribed fee, such as premiums for an insurance policy as disclosed below. Such persons may also indicate certain geographic area preferences, such as a person from Boston might want his or her image in Boston to exist for posterity, or even in other places nationwide, including internationally. Thereafter, such holographic images would be available for rentals by places such as department stores needing to provide customer service to point for example to where customers could find items in various isles. Such a department store offering a virtual person via the proxy hologram could position the holographic images in the isles with microphones connected to computing devices for the voice recognition process and provide answers and guidance to the querying public. Such holographic store attendants would be less expensive than live personnel; would work overtime without added charge, would never call sick or join a union with a potential foreboding strike work-action at some point in the future. The social implications of losing jobs for persons who need to care for their families is treated somewhere else, not being directly related to the disclosed material. We will refer henceforth to such proxy hologram attendants in any and all capacities as a Holographic Attendant or a Proxy Attendant. Further, the business model for the person wishing to be so immortalized as a holographic attendant (or a holographic lecturer, or holographic guide in a museum, etc.) would finance the overhead of the operation by funding the image dispatch on a continuous basis subsequent to the person's death. In one such embodiment, the person to be immortalized by the holographic figure may buy a membership in the organization of the commercial entity providing the service and then buy a life insurance policy with the beneficiary being the commercial entity providing the service. After the person's death, death benefits from the life insurance would finance that segment of the individual's memorializing operation.

Persons skilled in the art would be able to create other embodiments for Holographic Attendants, such as images of pets, horses for racing or even pornographic situations, where legal and appropriate, either in images of departed or even living persons of desire and appeal to audience, where appropriate.

On the other hand, there are plenty of images, video and TV aired material, especially of public figures that may lent itself for utilization as holographic attendants after their death. Such cases would need to be commercially arranged with the families of such person after their death, according to the business and legal rules prevailing in the locality where it is processed.

We describe below supplemental products and services as follows. People have been interested for a long time in having robots doing the work for them and in fact the word “robot” comes from the Russian word “rabota”, meaning, “work”. However, the robots produced so far, are mechanical and have no humanlike traits, though some are built to have an image of a person. The exception is the mystical Golem discussed below. Therefore the utility of the Holographic Attendant can be extended to other areas that supplement needed help provided by robot technology. Obviously, A Holographic Attendant is a virtual image and cannot assist in real work where muscles are required, while the robot having that required strength does not appear to look human. Thus, any person skilled in the art could build a robot for performing certain desired functions and any person skilled in the art could create a hologram of a Holographic Attendant. Thereafter the two creations may be combined so that the Holographic Attendant could do real work. Such combination could take the form of the hologram created around the actual robot as an ambient machine, where the robot is “embedded” inside it. In another embodiment discussed below, we introduce the combination of Holographic Attendant and automated mechanical functions.

In one embodiment of the proxy attendant, it is utilized for easing bereavement of persons who lost a dear one, such as a parent, spouse or child. Many times we have heard a surviving person such as a surviving spouse of a departed says: “now that I need you more than ever, you are not here”. Well, that's until now, since the proxy attendant can assist in providing some form of assistance to answer the need. Notwithstanding such a technical solution and technical feasibility, attention is drawn to the fact that psychological assessment that is outside the scope of this disclosure, may be required to determine if such a holographic attendant is psychologically warranted, or a closure is preferred, albeit all the pain associated with such closure in any particular case, or even in general.

The process for the aforementioned example begins when the spouse was still alive and visited a proxy attendant facility to create a proxy figure for himself or herself. Such figure can now be available for the widow or widower, saying the exact same words he or she would have said would he or she have been alive and sounding exactly like him or her when alive.

When creating a holographic figure, there may be times when smell may be desirable. Thus, in one embodiment a holographic figure is created and a capsule emitting odor or activated spray is added to the system. Said added smell can be automatic, time released or triggered by a code or event. Such said smell utilities can find variety of usages. For example, if one has a dog that requires the presence of at least one specific person in the household to become calm, a proxy attended of that's person's image augmented by at least one of a said, holographic image, odor and voice can provide a solution.

Another example of a proxy attendant is a hologram of at least one large animal, such as a dog that emits frightening sounds, such as growl or barking and shows exposed teeth as if ready to attack and do harm. Said proxy-attendant-dog can be activated in a specific premise when an intruder breaks into said premise. Even when the public at large is aware of such proxy-attendant-dogs, it is unlikely that an intruder would hazard a chance that it is such a said proxy attendant rather than the real thing. Similarly, one can arrange for a product that shows people moving around in a house and talking in order to prevent a break in when the party is out of home or away on a trip.

The animal proxy attendant hologram may also show movement toward, away or circling around any intruder, including jumping and chasing, giving the impression that it was not injured if hostile activities by any intruder took place, such as shooting at the animal and thereby not giving away the fact that the animal is only a hologram. Said animal proxy attendant responds to activation of sensors in the premise indicating a break-in and various activities of said intruder. Said activation occurs when at least one of the sensors so indicates. Said sensor indication activates at least one of a animal proxy attendant and an automatic call to at least one of a authorities and private entity reporting a break in.

In one embodiment such an animal proxy attendant may be activated by a person who could press a remote control key, positioned in at least one of a place of a structure, such as a house, office, hallway, or staircases. Said remote control key may be positioned on the person herself or himself, such as on a body part. Such a device may create a deterrence from a person who causes or threatened cause harm to the individual activating said remote control key, or is in the process of committing an assault, burglary, rape, etc. A Activating device worn on a body of a person may me in such form of a on a necklace, band, or even a fingernail. Detailed description of said fingernail alarm device was provided in a continuation to U.S. Pat. No. 7,287,009 sent to patent attorney Mar. 10, 2008.

In one embodiment, voice recognition is employed with said aspect of the product, such as an animal proxy for assistance to the person feeling threatened who may activate the hologram of the animal proxy attendant with its emitting sounds by calling a code name such as a name of an animal. Thus, a woman for example could call loud the name of her real dog or imaginary dog, or another code name, such as “help” for the contraption of said animal proxy attendant to me activated.

A security embodiment of a proxy attendant may be utilized for official figures where a “double” is warranted in order to safeguard the physical safety of said official. Said embodiment will present to the public the proxy attendant, such as that of a president that is exposed to the public, while in reality it may be a proxy attendant that looks and behaves like the president who in reality is secured in a different location.

As prices of gasoline are rising, traveling for meetings whether by airplanes or even cars become a costly item and alternatives are being explored. Video conferencing is a known art, however, a face-to-face meeting, such as around a table is considered advantageous to the participants. The instant disclosure presents an embodiment where conference participants enable their look-alike proxy attendant to partake in a conference session. As such, the instant disclosure presents improvement to video conferencing, enabling a proxy meeting to take place where each participant stays in his or her own locality, yet perceives himself or herself being in a room with the other participants in a virtual reality situation, seeing and hearing everyone sitting around the table except that there is no real assembly at a table. Namely, no real people around, only the virtual reality of proxy attendants image of all the attending participants providing that sense of reality. We will refer to it as the Proxy-Attendant-Conference (PAC).

Certain conditions and technologies may contribute to a smooth process of said PAC effect as detailed herein below:
All members of the PAC may be sitting in an appropriate chair localized in a position where laser photography will take the video image of the participant and all his or her movements, while a recording device will take all vocal expressions of said participant.
All participants during a specific session may have the same background imagery that will be seamlessly patched together at the receiving end.
All may be transmitted in real time to each and every participant, once it has gone through the integration process.
Likewise the image of the table may be the same for any particular session.
Participants may choose such images as the background image, table image, or lighting image from the available options provided, providing the imagery is the same for all during any particular session.

Further, it is well established that persons who are dying, benefit greatly from other people being around them at the difficult time just before and during the departure from life. However, not everyone is blessed with attending family, has friends or receives such attention at a hospital ward that is busy. Holographic Attendants may serve such noble purpose, either being part of the staff of the facility attending to the dying person or being established for home use; namely they may be bought or rented for such purpose. As can be seen from the above, many applications and other embodiments may be beneficial to individuals and the public.

Another aspect of importance disclosed below relates to languages. It is anticipated that most of the communication between survivors and the proxy of the departed would be conducted in the same language that is local to the person signing up for the service as the originator. However, in a global economy and wide global travel, where persons live in different areas rather than their initial domicile, or might have offspring of first or second generation who might speak a different language may pause an inconvenience if not a problem. To this end, translation services are built into the program for either the live person or the proxy for the departed person. Further, even communication between hearing and seeing parties on one side of the communication process and parties on the other side of it, who are with special needs, such as being deaf, blind, or deafblind, could benefit from proper translation, transliteration or conversion among languages. These could take place with the available tools that are known in the art at that time. As a specific example consider an originator of service who is deaf and originates the material using Sign Language. Such person may in one embodiment also provide the movements and a database of intermediate movements of hands and arms according to existing prior art by Liebermann, et al.; U.S. Pat. No. 7,774,194. Such database may later be used in service delivery to construct sentences in the spirit of the departed deaf originator and be seen as a proxy delivering same as an answer to a query by a surviving descendant, all in seamless signing motions. If such surviving descendants can communicate only in sign language, any tools known in the art may be utilized to convert the sign language to text that would be analyzed. Said tools of the art may be found in work done by Liebermann in U.S. Pat. No. 08/653,732 and U.S. Pat. No. 09/603,247.

Establishing the activation dates is disclosed next. There are various types of activation dates for individual activities of the herein-described invention. The Start date is an activation date occurring when any specifically specified event may be designated by at least one of an Originator and the service provider. Some examples are provided in the following list. Namely, such events may be the death of the Originator (described below), a graduation, birth of a child, promotion, or any other types of activation related to the case of a particular Originator.

There are various modalities to establishing Activation Dates (defined below). Local death notices and obituaries appear in newspapers and find their way to the web where search engines collect them and they are readily available for the public.

The Product and Service levels provided herein are not binding and represent a reduction to practice in some embodiments. Amenities could be interchanged or be replaced among the various levels presented, based on the particular business model constructed for a certain embodiment.

For ease of segmentation that indicates progression of product utility articulation, the description below is cast using a business model. The standard product level referred to as Level 1 is provided by a business service (hereinafter the Service) enabling a person subscribing for it (hereinafter the “Originator”) to provide the service with the identities of parties who would benefit from it (hereinafter the “Target Parties). Giving names, telephone numbers, postal and email addresses and other vital statistics, such as dates of birth. Further, the Originator also provides a list of designated activities (hereinafter the Activities) desired for the future. For example, the Originator may be a father of a daughter who would be the Target Party and the Activity would be the daughter's birthdays. The service monitors information about the Originator, to find out when the Originator dies (hereinafter the Start Date), (monitoring modalities are described herein as well), and after the Start Date at any birthday of the daughter a message is sent by the proxy of the father depending on the level designated. Namely, a postcard signed by the father who provided the Service with signature sample or an email sent if that was the designated modality, or a voice message in the real voice of the father who recorded it or other modality such as electronic. The daughter or her authorized representative can cause the yearly appearance of the greetings to be suspended for a time or indefinitely. Other examples of designated events may be graduation from school or college, birth of an offspring, etc. As was already mentioned, Consideration Points are built into the service, enabling a target person to cause cessation of future receipt of any kind of communication by a proxy of the deceased, as well as such aspects as pre announcements that a proxy would be speaking unless the party objects, including directions of how to stop the activity, delay it or abort.

The Bronze Product, referred to as Level II, is the utility product provided as product and service level (i.e., embodiment) enabling a survivor to conduct a Question and answer session (Q&A session) with the proxy of the departed. It is not just limited to a Q&A session but may also be utilized for receiving text (and in other product levels also voice, video and hologram of the originator narrating a story, singing a song or otherwise performing such as with a musical instrument and/or acting). Submitting questions and requests for guidance either by conducting it by postal mail or utilizing email is available in this embodiment. The computer system of the Proxy service includes software programs and artificial intelligence components enabling to simulate such aspects as the type of answers by content, idiosyncrasies and humor of the departed as pertaining to a proper answer to the question posed. Another option under this level is to conduct the session utilizing Instant Messaging (IM) or ICQ. When a Q&A session is conducted we introduce an Utterance engine and Linguistic engine where “Transitions” of speech segments are utilized to provide a fluent and seamless utterance of words and sentences by embedding them in the provided presentation. They are taken out from the database containing these components as produced by the Originator, as well as “Transitions” of words and sentences and content appropriate to answer the questions posed. The “transitions” are Originator specific database of words, gestures, tonality, grimaces, jokes, sense of humor, etc. that is picked out of the database and interjected into a reply when suitable and in the right location. Further attention to said “transitions” is provided herein as well.

An originator may install a suitable capturing device that is a facility that records voice (and in other product levels also physical appearance and movements, or captures text from writings and email produced by the originator). Said installation may be done in the office, at home, or on a mobile device. Such capturing may be done for a single occurrence or on a frequent basis, such as on a daily basis to provide a database for utility later on. Such utility may be a Q&A session, including the said specific database of personal idiosyncratic elements discussed above.

Specifically, we have four groups of what we call “Transitions” modeled after the arms and hand transitions in the U.S. Pat. No. 7,774,194 by Liebermann et al. However, where in the latter we had arms and hands that were fitted in the signing image to have seamless signing transitions, here we have three different types as follows:
(1) Body Parts Transitions
   There are eight (8) sub-transition groups listed below, where each can be fitted independently as well as in conjunction with any one or all of the other sub-groups into the image to produce a seamless appearance of the proxy person (e.g., the Originator) addressing the viewer. The sub-groups are:
   a. Lips, mouth and teeth transitions
   b. Eyes, eyebrows and forehead transitions
   c. Head transitions
   d. Hands and finger transitions
   e. Arms transitions
   f. Legs transitions
   g. Feet transitions
   h. Torso transitions
(2) Words and Sentences Transitions
(3) Content Transitions
(4) Vocal Transitions (laughter, crying, sighing, yawning, whistling, yodeling, etc.)
(5) Idiosyncratic fillers (e.g., “a”, “ammm”, “eh” “so” etc.)
(6) Humor, such as joking material, preaching wisdom, etc.
   The last three, i.e., (4), (5) and (6) may be utilized only in advanced product levels offering.

The Silver Product, referred to as Level III, is a level where guidance and/or Q&A sessions are of the same nature as in Level II with the added component of voice. Namely, either one or both parties to the communication (the survivor and the proxy for the departed) may utilize voice. The survivor's voice goes through voice recognition technology that exists in the state of the art and that is transformed into text fed to the product engine. The voice of the proxy for the departed may be the real voice of the departed deposited while the originator was alive. Said voice could have undergone voice recognition technology that was the state of the art either at that time or that is available after the death of the departed and provides as an improved recognition resulting in more accurate text generated form it). Such text is important for the linguistic tools and artificial intelligence tools that would pull out words, phrases and idiosyncratic elements to create appropriate sentences for the session and that would be then sounded back by the voice of the departed in as seamless manner as possible. Text may be provided in at least one of a joined with the voice and independently of it.

The Gold Product, referred to as Level IV, is the level where all previous level amenities are available in whatever combination desired. It includes Q&A sessions conducted in voice with the added service encompassing the availability of video of the figure and voice of the Originator, conducting messages or partaking in the Q&A. The technology utilized for said gold level may be as follows:
Database of video clips of the originator
Database of words and sentences of the originator
Database of body, arms, hands, fingers, head and mouth movement transitions
Artificial intelligence that is the state of the art
Text to speech
Voice recognition
Text to video generation
Seamless engine generators (e.g., movements, speech)

The Platinum Product, referred to as Level V has an added innovation of major upgrade to a real appearing image of a person not available to be there at the time. Similar procedure to the video appearance during the Q&A will be processed, except that instead of the video image there would be an interactive real time communication with a holographic figure of a person, such as the Originator. The holographic figure will be discussed in more detail below.

The next segment is the Commercial Product, referred to as Level VI. This segment encompasses holograms (i.e., the elements required for their activation). Said holograms may be created and stored in an appropriate database of the relevant persons. Such persons may be at least one of a Originators for the purpose of immortalizing their memory on Earth, and utilized for personal interests, such as in Levels I through V discussed above, or as proxy teachers, proxy health workers, proxy newscasters, proxy helpers in stores, etc.

Stores could be one of the markets to use a hologram of a proxy person as attendant, as discussed herein, which may ease personnel issues and be also more profitable. However, there are also times when such proxy holographic attendants may help in adding to security of people and sometimes even protect from harm, such as death as we see next.

There are stores that are open 24 hours 7 days a week and many of them have a single attendant. It had already happened that a perpetrator assaulted the attendant, such as when a robbery occurred. With the instant disclosure, the attendant service may be automated and instead of a real attendant a hologram of an attendant may make the needed motions to simulate the real person while automation will drive the functions of attending to the customer. Should a case such as a robbery occur and the perpetrator may try to hit the holographic attendant with a bat on the head or shoot the attendant, no bodily harm would occur as the bat as well as the bullets would pass through air and the holographic figure. Moreover, besides the safety factor, the cost to the store's owner may be significantly less than paying for human attendants, let alone that the burden of finding them, keeping an eye on honest transactions, etc. will be alleviated. Obviously certain security measures may also be installed in the store, alerting and possibly taking action if a violation occurs by a customer or any other party in the store.

While the above utilizes a store to illustrate the innovation, certain other examples, modalities and embodiments are likewise covered.

Further, such holographic proxy figures may act as helpers in stores where any question or direction a customer might have may be handled by such a holographic attendant(s). Besides the hologram, an artificial intelligence (AI) programs (such as neural networks and/or fuzzy logic) may provide the intelligent interpretation of what the customer requires, while speech recognition may translate to text the wishes of the customer and the text may be analyzed by the AI program to find what is needed as a verbal or physical response to the customer. A database with variety of responses, either canned responses or material responses constructed by the AI program on the fly in real time may be part of the complete program. Text to speech technology may deliver verbal communication to the customer, while facial expressions and movements of the mouth may be supplied by the relevant image technology utilizing mouth movements (transitions) as well as hand and head movements of the hologram, combining images of movements from the image database of movements to be assembled and delivered as a functioning proxy image of a person. It may be possible to provide a facility with a lower grade level of attendant, such as answering by video, voice or text.

Further, if we take the example of a store, then a store may choose either to position such holographic figures in the isles (which would not be in the way of customer traffic since they are not physical entities and the customers may walk through them), or decide to “beam down” such a holographic attendant to an isle where a customer requires help. A network of microphones may be positioned along the isles in order to pick up customer requests for help, as well as, specific questions or requests by the customers. Likewise, sets of laser lights installed in the isles may enable to project the holographic image when needed.

We continue with the store example. Automating for stores open 24 hours would require to coordinate movements of the holographic figure with motions of taking money, providing at least one of a change and receipt through an automated drawer so that there is no physical “contact” between the holographic figure and the customer, yet the coordination between speech, and motion of the hologram as well as the automated contraption may be orchestrated seamlessly. Movements and speech of the holographic figure would be changing according to situations. Induced variety may be provided under the same repeated situations by utilizing construct of random segments and random words that are appropriate to the situation, all put into a seamless stream that becomes visual and audible to the customer.

At least one of a software and firmware procedure(s) may handle all the randomized capsules obtained from appropriate databases that respond to searches, retrievals and combines all into a seamless presentation that may also be coordinating all segments and timings.

Not all proxy products or their derivatives require human or animal characteristics and parsing of segments, though in some cases they can add flavor. For example, a product embodiment of the proxy hologram may be a seasonal utilization of a still holographic picture in a true ecologically-friendly, multidimensional green Christmas tree, where no tree has to be cut down and people could rent the proper equipment to set an extraordinary tree fit to their required size with their desired ornaments and allotted space. Such holographic trees may come ready-made, or customers may come to proxy depots to trim a tree from the variety of ornaments made available and suiting their own taste. Subsequently, the hologram picture is taken for delivery to them. Subsequently, the tree in the proxy depot is stripped back and ready for the next customer to trim and take the laser picture. Adding flavor to such a tree may also be voice with the familiar “Ho Ho Ho Merry Christmas”, movement where the tree is moving from one location to another as pre-determined and other variations as desired. A Santa holographic figure may also be acquired in conjunction with the holographic tree or independently. Various variations may be offered such as casting the Santa in a particular image of a certain person or child.

Holograms of pets may be created either at home or in proxy depots with the proper equipment. Such proxy figures may be still, in video or holograms created, including a dynamically moving hologram that could include also other pets and/or at least one human being(s). Such products may be utilized for a variety of functions, such as to placate an animal resting in a home where the owner is away, as a game for a cat to chase a holographic mouse, etc.

Obviously a holographic pet or a proxy of a living human being may be created for other utilities, such as placating a baby going to sleep or “keeping company” to an infant or child while the parent is busy with house chores away from the vicinity of the child. In the latter case a proper monitoring and alarm-generating facility may inform the parent when immediate attention is required for the child.

It should be noted that wherever this disclosure mentions a holographic figure, it means at least one of a still figure with one of no moving parts, a moving of lips, and a full dynamic figure that can move “its” various body-parts.

An extended embodiment of the proxy product in the instant disclosure relates to at least one of a memorializing a human being, an animal or a situation. We congregate such elements under the heading of the Cemetery product as disclosed below.

It is a known fact that many people have an interest in memorializing themselves and have been doing it by leaving a legacy of their work, such as written books, art work, music, creating a library of their deeds or bequeathing money for constructs or projects that would carry their names. We have also encountered in this disclosure another form, such as the proxy attendant. Further, some persons may be interested in memorializing close persons to them, whether family or otherwise, as well as figures that appeared in their lives. We are all aware of such accepted forms as tombstones or the pyramids in Egypt.

The ability of people to have their holographic image taken for later distribution as a way to memorialize their entity has already been disclosed hereinabove. Further, a person may as disclosed within the parameters of this instant disclosure take holographic images of beloved pets in order to memorialize them for later in life, which is an extended step to widely practiced taking pictures or videos of said pets or of people. This instant disclosure covers also an embodiment that is dedicated specifically to the memorialized aspects of at least one of a person and a pet, that goes beyond the physical cemetery and creating turning one's private cemetery into world wide exposition utilizing the Internet.

In this embodiment, a web site is created as an Internet open-cemetery, where persons may upload still or moving images, text and sound of their object of interest, such as human(s) and pets. Further, proper identity may be created, such as a tombstone that can be ornate, write about the memorialized party what might be desired to be memorialized, “plant” electronic flowers and shrubs around, change them, or create stories and images, such as movies or video about the person or pet. When the state of the art in technology enables it, such presentations may also appear as thee-dimensional holograms “coming out of the screen” to form vivid appearances.

Potential commercialized rules for the disclosed Internet cemetery are provided herein as further articulation of the disclosed product and service as follows.
A proxy web cemetery is created for at least a person, an animal or a plant.
Everyone may enter information as long as it is by the rules.
Some of the rules cover type of contribution to said Internet cemetery.
Contribution to Internet cemetery site is only for the expired, such as people, animals, plants, geographic location, constructs or events.
Pre-posting, located in an out-segmented section is permitted, preparing ahead of time for self or others and becoming available for open posting only upon the expiration of said subject in the pre-posting.
Possible inclusion rule allowing only related parties or accepted invited parties, including self-invited, may contribute to any specific Internet cemetery.
The electronic cemetery may be by subjects, such as a cemetery for musicians, cemetery for poets, for scientists, for a family member, friend, politicians, or any subject desired by the original creator of said cemetery.
Each entrant may be in more than one category, such as when a specific person may be an entrant in all of the categories of famous persons, family tree, artist, politician and scientist.
A file offering ideas about subjects for assembling information on an entrant for creators of entries and contributors may be available for all to consult, containing suggestions, such as obituaries, what the entrant had done while living, awards won, related family members, special articles or ceremonies related to said entrants.
Contributed material to the Internet cemetery may be in any form available in the art, such as text, drawings, pictures, video, voice of the entrants, parties communicating with said entrant or related narration, sound, music or holograms. Sound includes perceivable frequency of vibration, such as barks of dogs, sounds of cats, birds or sound of water, such as in a waterfall, ocean, or shower.
A special category and its related database of sounds, whether related to any specific entrant or not may be kept and available online for inclusion in the Internet cemetery or for other purposes. Said such sounds may be sounds of persons, animals, nature, such as rainfall, wind or leaves of trees exposed to wind and man made situations, such as locomotives, trains, busses, air drilling equipment or construction.
The Internet cemetery may contain indices and various tables of content, enabling to find entrants by such search aspect as name, category, year, era or any suitable identification, including an index of indices.

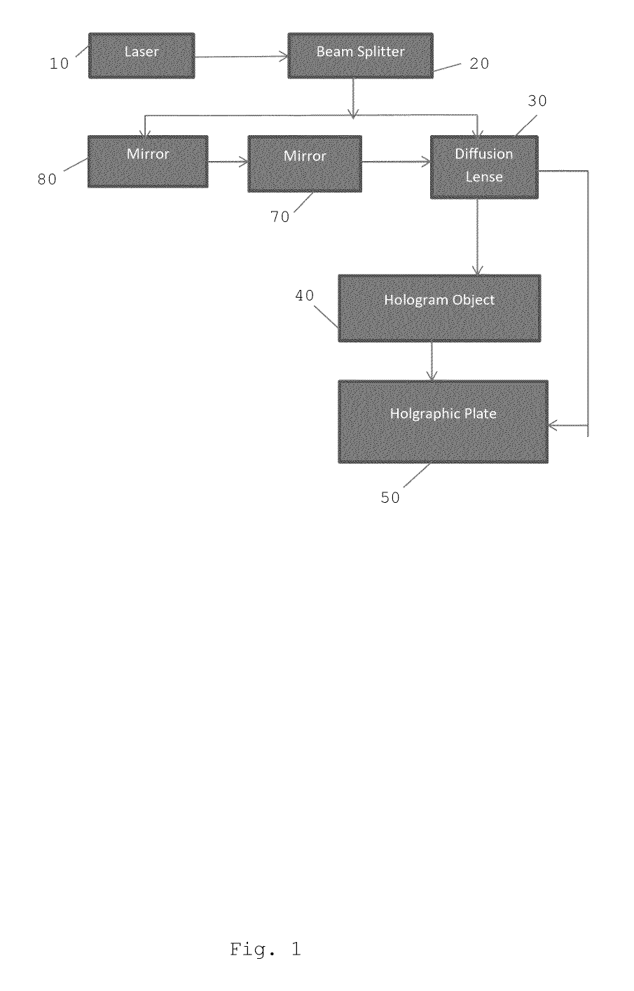

Referring now to FIG. 1, it illustrates known art of creating a still hologram figure. The laser in (10) sends a beam to a beam splitter (20). The beam splitter in (20) splits the beam where one goes to the diffusion lens in (30) and the other to the mirror in (80). The diffusion lens in (30) diffuses the beam to the object we desire to photograph as a hologram in (40), such as a person or a pet. The object in (40) appears on the holographic plate in (50). The mirror in (80) reflects the laser beam to another mirror in (70) that further reflects it to a diffusion lens in (60) from where it ends up at the photographic plate in (50).

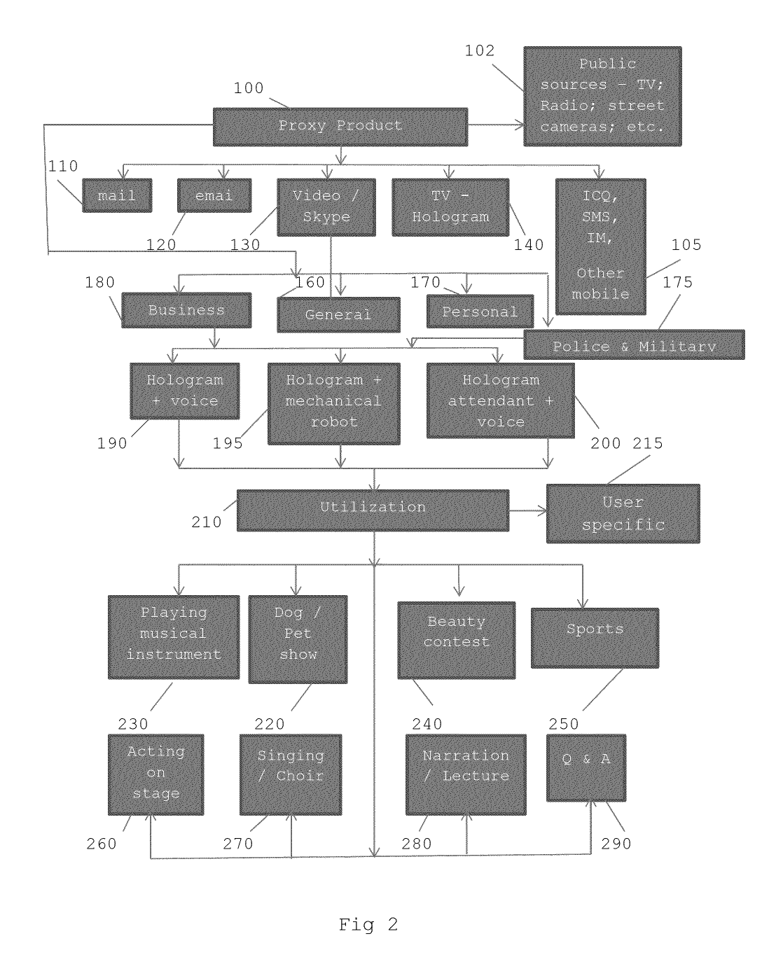

FIG. 2 illustrates a general description of the proxy product for either asembling data and information for the databases to be used in the Proxy presentation or for actual delivery of certain Proxy material. Starting from (100) one could go to any of the five levels described above. Either utilizing only mail as in (110); utilizing email in (120); video or Skype in (130); or the holograms in (140). Another source of material, as well as medium for delivery is the public arena shown in (102) that could be TV, radio, surveillance cameras in public locations and other such electronic devices as related to their location. Presentation of a Proxy on TV could also take the form of a three dimensional or hologram when feasible and such TV hologram is shown in (150). Needless to say that the TV is also a source for obtaining material for said database, when content is captured by such means as a DVR. Also ICQ and IM facilities are available in (105), where a person could conduct an IM or ICQ session in (105). Further information related to mobile communication devices in (105) may also be a source for information gathering for the proxy image disclosed herein or for delivering Proxy content to a living party. From (100) the proxy product is utilized either for personal in (170), general in (160), for police and military in (175), or business in (180). If the business route is taken for example, then it could be holograms and voice in (190); hologram and mechanical robot in (195); or hologram and voice attendants in (200). In either case we could see utilization in (210) of a performance, such as a concert or opera; dog shows in (220); playing a musical instrument in (230); beauty pageants contests in (240); sport activity including horse races in (250); acting on stage in (260); singing or choir in (270); narration in (280) or questions and answers (Q & A) in (290). Police and Military in (175) have their own specific needs for operation that preferably are not detailed here and when it comes to utilization in (210) it is directed to the specific operative needs in (215), such as swat team operations or hostage negotiations.

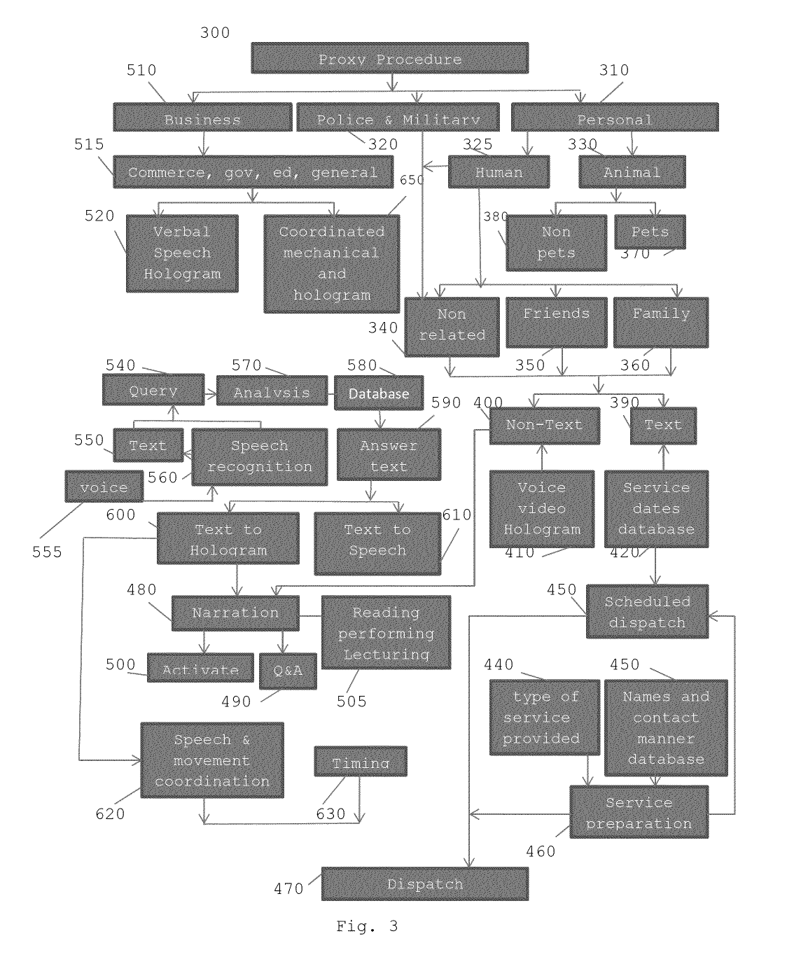

FIG. 3 illustrates the proxy product utilized in a personal as well as in business. The proxy product in (300) may be utilized either in a personal manner in (310) or in business in (510). In the personal we have either a human in (325) or an animal in (330). If it is an animal in (330) then for pets we move to (370) and for non-pets (380). If it is human in (325) then it may be family in (360), friends in (350), or non-related in (340). Any one of the latter three may end up either as text in (390) or non-text in (400). The non-text may be voice, video or hologram in (410). The non-text in (400) leads either to narration in (480) that may be reading, performing or lecturing in (505); to Q & A in (490) and activities in (500). Text in (390) relies on service dates database in (420), name and contact manner database in (430), type of service to be provided database in (440). The service dates in (420) lead to scheduled dispatch in (450). Also the other databases in (430) and (440), that leads to preparation of the appropriate service in (460) leads then to the scheduled dispatch in (450) as well. Finally it is dispatched in (470). If a proxy product is used in business in (510), that may be commercial (that includes services from assistance to medical, such as in psychological or psychiatric counseling), government, educational, or general in (515). In (520) only verbal speech and holograms are provided, while in (650) it is a coordinated hologram with automated mechanical functions (of a robot).

After (520) there is an input query in (540) that is generated either by text in (560) or by voice that undergoes voice recognition in (550). Analysis of the query occurs in (570), then database is checked out in (580) and an answer text is created in (590). From there, text to hologram movements happens in (600) and text to speech in (610). Speech and movements are coordinated in (620), and timing is provided in (630) and it is finally dispatched in (640). It needs to be mentioned that police and military in (320) is not elaborated here in order to keep such material treated as classified.

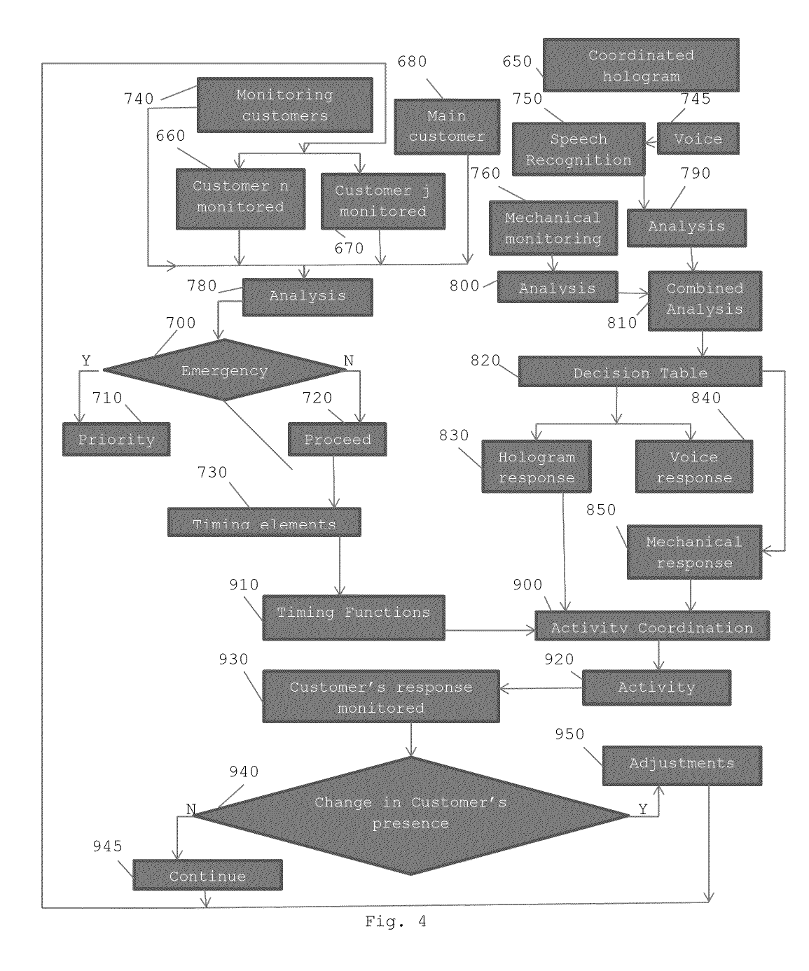

FIG. 4 illustrates a coordinated hologram with automated mechanical functions starting from (650) in FIG. 3. The main customer is in (680) and the system also monitors other customers, such as customer j in (670) to customer n in (660). The input from the customers is analyzed in (690). In (700) the system determines by its provided parameters if there is any emergency. If an emergency exists, then it gets priority in (710), otherwise it proceeds in (720) and timing elements are established in (730). Monitoring of customer motion takes place in (740) and analyzed in (780), speech recognition of customers occurs in (750), which encompasses multiple languages as well as sign language and then analyzed in (790), and mechanical functions (of the robotic functions) needed for coordination with the holographic figure are monitored in (760) and analyzed in (800). The combined analysis occurs in (810) and the decision table is utilized in (820). The system then prepares the different modalities of response. The hologram response is prepared in (830), the voice response is prepared in (840) and the mechanical functions that need to operate for the response are prepared in (850). The forthcoming activity is coordinated in (900) and timing functions are added in (910). Resulting activity is dispatched in (920) and the customers' responses are monitored in (930). The system then determines if there are any changes in customers' presence (i.e., customers leaving the store or coming into the store) in (940). If there are changes then adjustments occur in (950) and then fed back to (660), (670) and (680). Otherwise the system reverts back for continued operation to (660), (670) and (680).

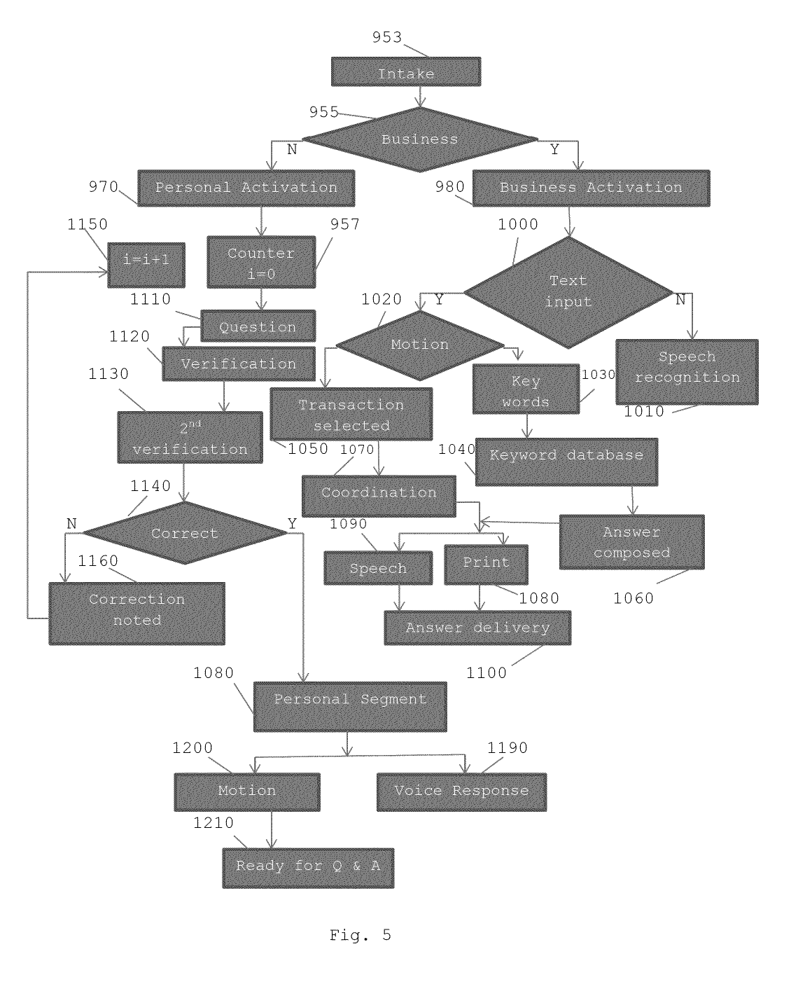

FIG. 5 illustrates the intake analysis starting from (953). In (955) it is determined if the intake is for a personal or a business case. If it is for business the segment (960) is activated, whereas if it is for personal segment (970) is activated. In (1000) it is queried if the business activities will be undertaken in text input and if the answer is negative then speech recognition occurs first in (1010) and only then it is determined in (1020) if motions are required. If no motions are required then key words are selected in (1030) and then the database of keywords is checked in (1040) and an answer is composed in (1060). If it is determined in (1020) that motions are required then while keywords are selected in (1040), transitions are selected for the motions in (1050) and coordination of answers from (1060) are coordinated in (1070) with motions selected from (1050). While in the text mode answers are printed in (1080), in the motions mode the text feeding (1080) turns into speech in (1090) and together with the coordinated material from (1070) the answer is delivered in (1100).

In the personal mode (970) a counter is set to i=0 in (957) and the (presumed) question is determined in (1110) and verified in (1120). An optional second verification is provided in (1130). In (1140) it is determined if the question was correctly determined. If not, the counter is upgraded in (1150), the correction is noted in (1160) and reverts back to determine the question in (1140). If the determination was correct in (1140), then the system proceeds in (1170) and the personal segment [in FIG. 5.1] is consulted in (1080). Thereafter voice response is handled in (1190) and motion in (1200). The system is now ready in (1210) for the Q & A session.

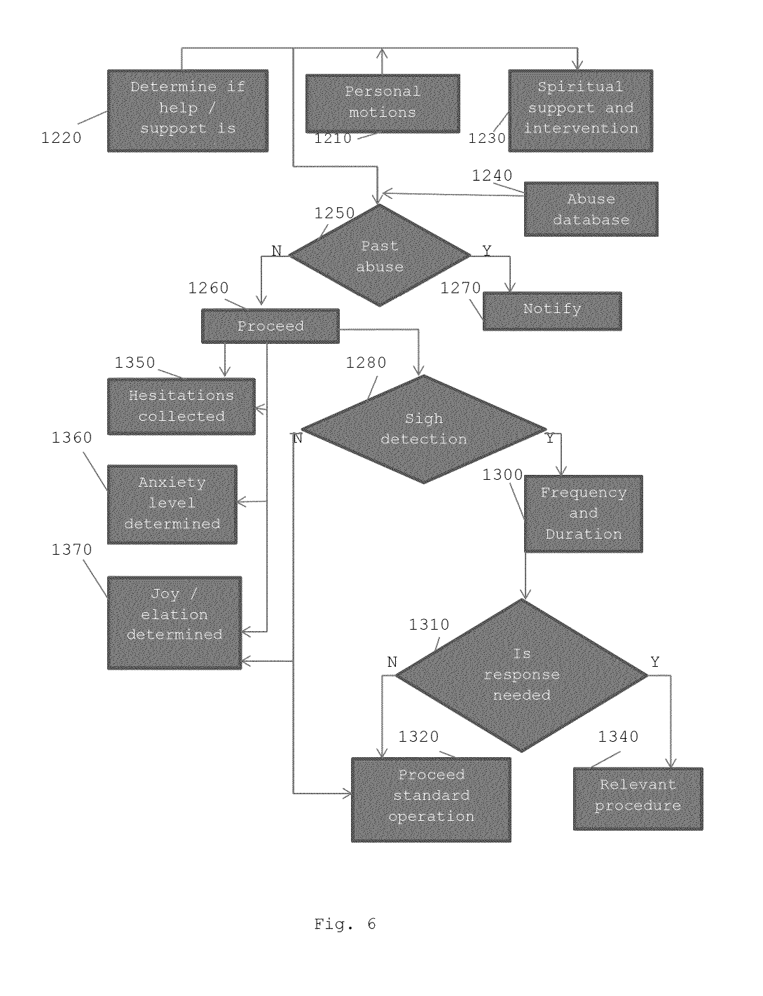

FIG. 6 illustrates the personal idiosyncratic segment in number (1180) of FIG. 5. Both personal motions in (1210) as well as determining if help support is needed occur in (1220). In (1230) a determination is made if spiritual support is warranted or intervention should take place. In (1240) we look to determine if abuse exists or existed. If abuse is determined in (1250) then proper notification of such occurs in (1270), otherwise the system proceeds with normal functions in (1260). If sighs are detected in (1280) then their frequencies and duration is monitored and established in (1300). In (1310) we query if response is needed, and if affirmative we proceed in (1340) to the relevant procedure, otherwise the system proceeds in standard operation in (1320). Elements indicating hesitations are collected in (1350) and anxiety level is determined in (1360). Elation, happiness, joy, etc are determined in (1370).

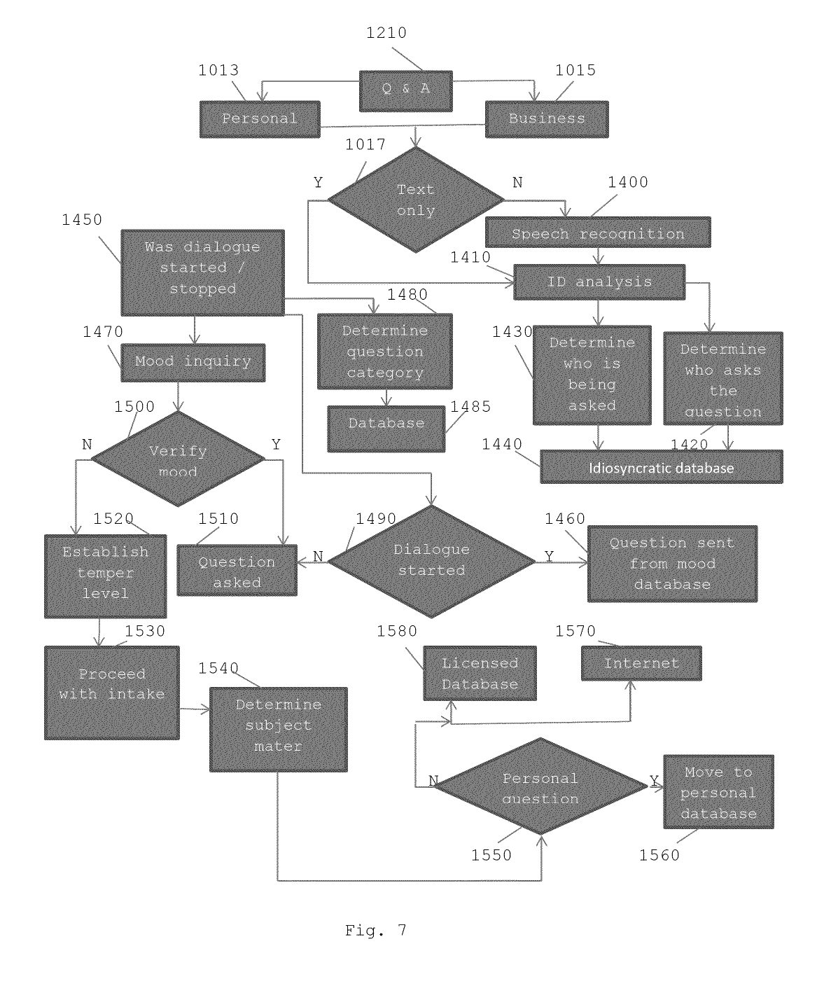

FIG. 7 illustrates the Q & A session of (1210) in FIG. 5 that is shown here with more detail. The personal Q&A appears in (1013) and the business in (1015). In (1017) it is determined if the Q&A will be handled strictly by text and if negative we first determine the speech recognition in (1400). Next we go through the identification analysis in (1410). In (1420) we determine who is asking the question and in (1430) we determine who is asked the question. We next move to the database of the special idiosyncratic elements in (1440). In (1450) we determine if a dialog has started. In (1470) a mood inquiry takes place and in 1480 the category of the question is determined. The dialog segment starts in (1490) and in (1500) we determine if mood needs to be verified. If affirmative then proper questions are asked in (1510) and then we check in (1450) if the dialog started. If affirmative then question from mood database is sent in (1460). If it is determined in (1500) that there is no need to verify mood then in (1520) we establish the temper level for the communication and proceed in (1530) with the intake of questions followed by determining in (1540) the subject matter (this is a similar procedure used in Touch Language, U.S. patent application Ser. No. 10/718,023 filed Nov. 19, 2003 by Liebermann). In 1550 we query if it is a personal question. If affirmative then we move in (1560) to the personal database for answers, otherwise the Internet is checked for answers (e.g. utilizing Google) in (1570) or a specific properly licensed database of Q&A is consulted in (1580) (such as Ann Landers, Eloise, etc.)

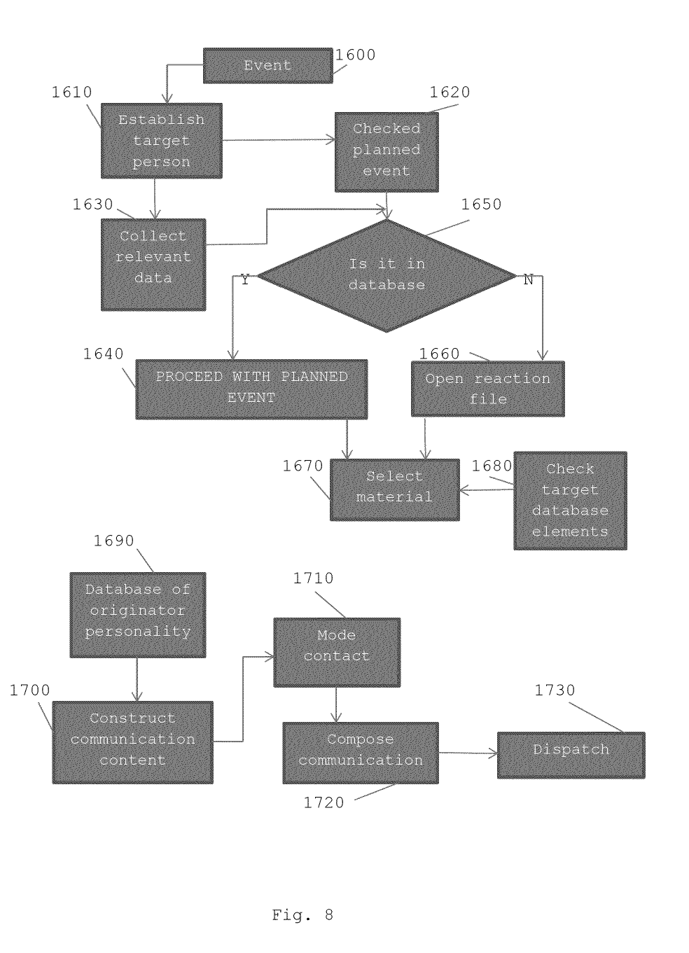

FIG. 8 illustrates unexpected events. Starting for (1600) we establish in (1610) the target person as contracted for by the originator and check in (1620) the database of planned events. In (1630) we collect data that is related to the target. In (1650) we determine if it is in the database. If affirmative we proceed with any planned events in (1640) (such as sending a birthday card), otherwise a new reaction file is opened for the event in (1660). In (1680) the database of elements related to the target is checked and then the system proceeds to (1670) to select material for reaching out content. In (1690) we check the database of elements related to the personality of the originator and in (1700) we utilize the originator's idiosyncratic behavior elements to construct communication content. In (1710) we select the correct form or mode of contact, such as mail, email, phone call, etc. and compose the communication in (1720). It is dispatched in (1730).

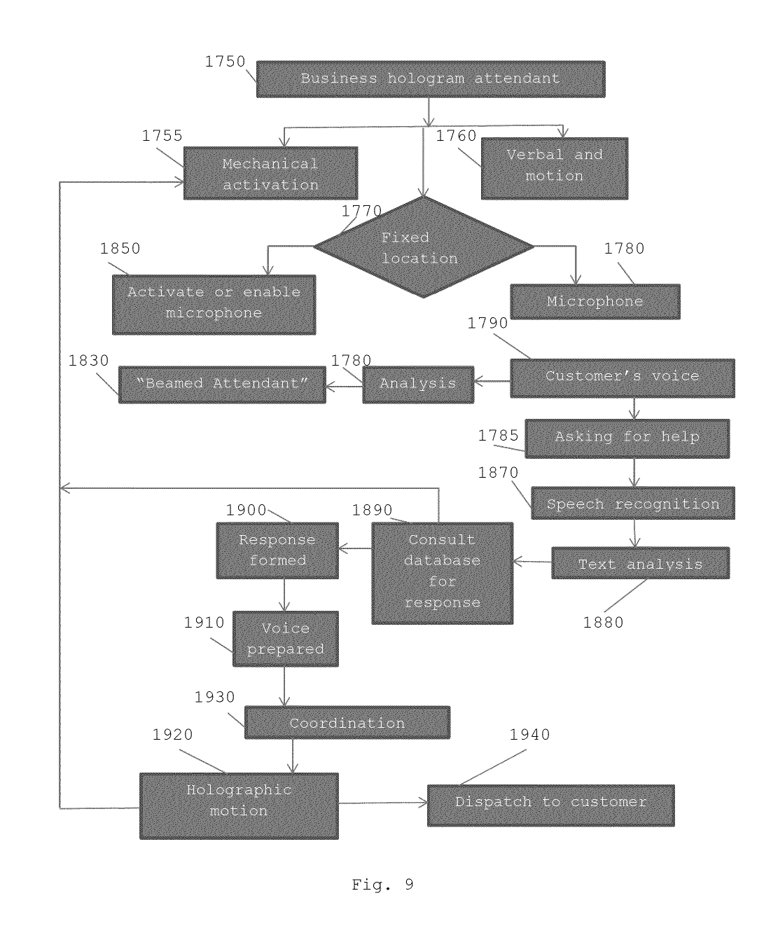

FIG. 9 shows the basic functions of holographic attendants in a particular embodiment. This is a business situation starting in (1750) and if it is a holographic figure coordinated with a mechanical device it is activated in (1755) based on FIG. 4. Otherwise, verbal and motion guidance and support for customers are activated in (1760). In (1770) it is determined if the holographic attendants are in fixed location. If they are not then in (1780) only microphones are dispersed in various locations with laser beams ready to “beam” a holographic attendant to be visually seen by people (such as a store). Voice of people, such as customers is picked up in (1790) and is analyzed in (1800) for trigger words (or key words) as well as ascertaining the customer location. The holographic attendant is then “beamed” to that location in (1830). The speech is then undergoes speech recognition in (1870) and moves to text analysis in (1880). If it was determined in (1770) that the hologram figure is in a fixed location it either activated with the microphones operating in (1850) or is simply enabled if already there. The customer asks for guidance or help in (1860). After undergoing speech recognition in (1870) and text analysis in (1880), the database is consulted for response in (1890) and a response is formed in (1900). Voice is prepared in (1910) and hologram motions in (1920) and are both coordinated in (1930). The response is dispatched to the customer in (1940).

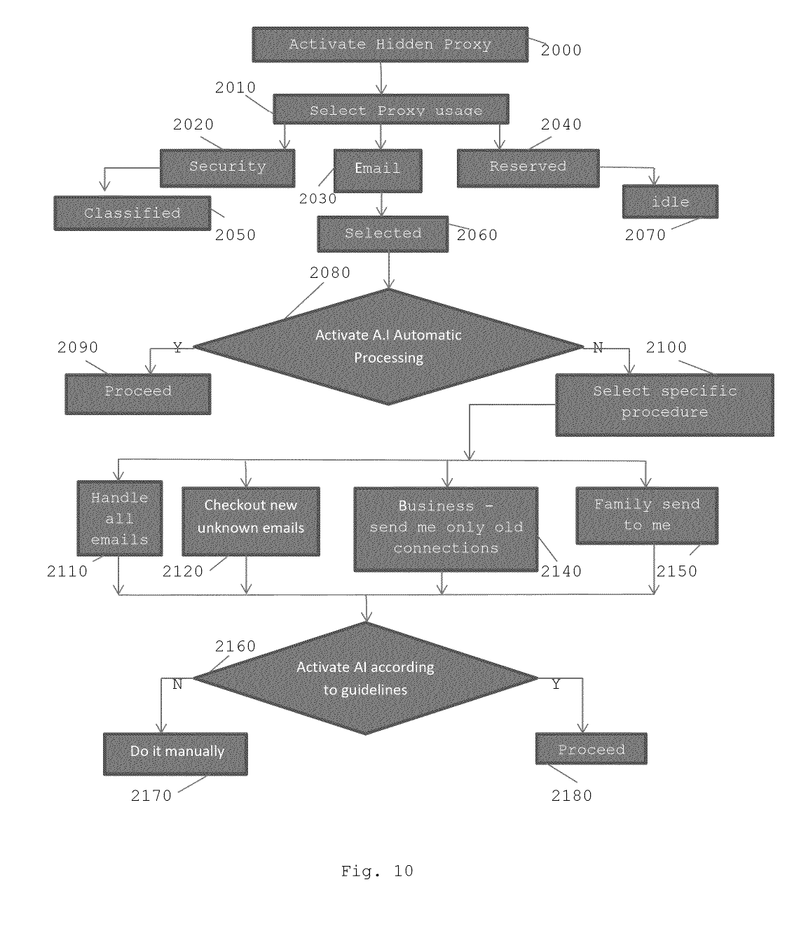

FIG. 10 illustrates the personal email butler. The hidden proxy that may just be a known proxy operating in the background is activated in (2000). The proxy usage is selected in (2010), which may be a security proxy in (2020), which is classified in (2050) so no further detail is available, or the email proxy in (2030) that is basically the personal email butler. Another selection is a reserved usage in (2040) that is not identified at this stage and therefore the system idles in (2070) if it currently ends up there.

If the personal email butler in (2030) is selected in (2060). Once selected in (2060) it is queried in (2080) whether to activate automatic. If the answer is positive, the system proceeds in (2090) to operate according to the automated procedure. Otherwise, if the answer is negative, a specific procedure is selected in (2100). In the latter case the electronic email butler can either check all emails in (2110), check only new unknown emails in (2120), or be instructed in (2140) to send to filter out for the business recipient only old connections and/or emails that were sent by family in (2150). The system then queries in (2160) whether to activate all according to the guidelines and proceeds in (2180) to do so if the answer is affirmative. Otherwise, if the answer to the query in (2160) is negative it calls for manual activation in (2170).

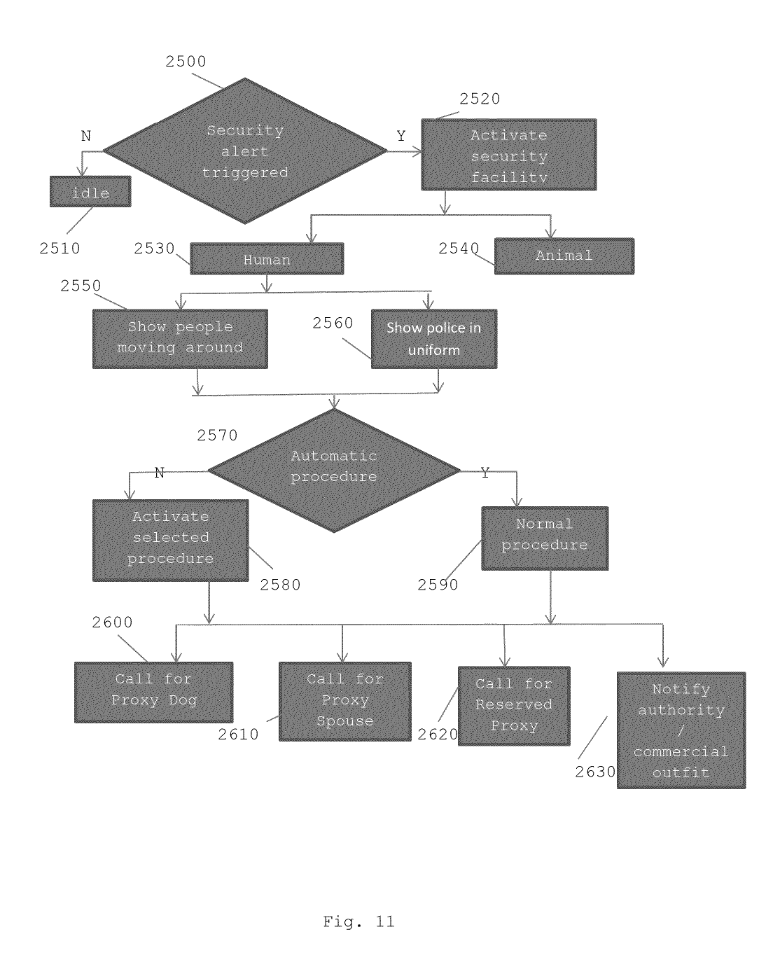

FIG. 11 illustrates the proxy for security. The system is queried in (2500) whether a security alert was triggered. If the answer is negative, the system idles in (2510) and when it is affirmative the security facility is activated in (2520). Then it is either animal in (2540) or human in (2530). The animal in (2540) may be a dog that shows itself by either a vocal form such as bark or snarl, and/or visually by such form as a hologram. The human(s) in (2530) may manifest itself may be either vocal and/or visual. If activated inside a residence or commercial outfit it may show people moving around as in (2550) for deterrence purposes or may show police in uniform in (2560). The system inquires if a automatic procedure is required in (2570). If the answer is affirmative, then normal procedure in (2590) takes place. Otherwise, if the answer is negative, then selected procedure is activated in (2580). Such procedure may be calling for a proxy dog in (2600), calling for a proxy spouse in (2610), notify or activate a commercial outfit of security or the authorities in (2630), or call for a proxy that is held in reserve in (2620).

As can be seen from the foregoing description, communications with a proxy for the departed, utilization of the proxy technology for security and safety as well as virtual cemetery have been provided. While the present invention has been described in the context of specific embodiments thereof, other alternatives, modifications, and variations may become apparent to those skilled in the art having read the foregoing description. Accordingly, it is intended to embrace those alternatives, modifications, and variations.

What is claimed is:

1. A method for at least one of a communication from and communication between at least one of a at least one person(s) and at least one animal(s) for delivering at least one utterance(s), wherein the communication from is from at least one of a at least one person(s) and at least one animal(s) and wherein the communication between is a communication between one of a at least one person(s) and at least one animal(s), and at least one of a at least one another person(s) and at least one another animal(s), wherein said at least one of a at least one another person(s) and at least one another animal(s) is physically at least one of a not present at and not partaking in said communication.

2. The method in accordance with claim 1 wherein said at least one of another person(s) and another animal(s) that is at least one of a not present at and not partaking in said communication is at least one of a alive and dead.

3. The method in accordance with claim 1, wherein said at least one of a another person(s) and said another animal(s) is represented by an electronic proxy comprising at least one of a text, voice, image, video, Skype, hologram, and any other technology available in the art.

4. The method in accordance with claim 3, wherein said communication by said electronic proxy comprise activating a mechanical device for affecting physical contact wherein said physical contact mimics a real physical contact by the at least one of a said another person(s) and said another animal(s) represented by said electronic proxy.

5. The method according to claim 3, wherein said proxy benefits for said representation from information available in at least one of a information gathered during said representation and information from at least one database(s), wherein said information comprises at least one of a text, images, voice, tonality, mannerism(s), smile, laugh, sigh, facial expressions, breathing pattern, thought content and thought process.

6. The method in accordance with claim 3, wherein said proxy further responds to triggers supplied by said information from at least one of a said database(s) and information contemporaneously collected in said communication, wherein said triggers comprise at least one of a current and stored information collected from at least one of a ambient situation occurring, presentation of said person(s), presentation of said animal(s) comprising voice, tonality, mannerism(s), facial expressions comprising at least one of a eyes, nostrils, mouth, teeth and tongue, tail, breathing pattern, position of head, position of limbs, assault weapon exposed, commands delivered, questions asked, remarks made, remarks delivered, and any form known of at least one of a at least one expression(s), at least one activity(s), at least one communication(s) of at least one of a human(s) and animal(s).

7. The method in accordance with claim 3, wherein said at least one representation(s) by at least one electronic proxy(s) for at least one of a said another person(s) and said another animal(s) personifies at least one of a trait(s), mannerism(s), wits, mood, inquisitiveness, at least one behavioral activity(s), expression of sadness, expression of happiness, expression of irritation, expression of fear, expression of surprise, expression of amazement, expression of disappointment, at least one of a steady voice and quivering voice, at least one motion(s) generally accepted as at least one of a threat, retreat, attack, gentleness, compassion, hate, affection, and love, and at least one other of at least one of a personification(s), action, and function according to at least one of a situation at hand, response, and following pre-prepared plan.

8. The method in accordance with claim 1 wherein said at least one of a person(s) and animal(s) is at least one of a at least one of a relative(s) and related party to said at least one of a said another person(s) and said another animal(s), a customer in a commercial facility, a visitor to a house of worship, an attendee(s) of a non-secular activity, attendee(s) to a secular activity, a visitor to a governing body, a delivery person(s) in at least one of a political gathering, an academic environment, a business gathering, an entertainment gathering, a political gathering, a transportation customer(s), and at least one other person exposed to personification of at least one of a said another person(s) and said another animal(s).

9. The method in accordance with claim 3, wherein said at least one electronic proxy(s) represent at least one of a at least one of a relative(s) and related party to said at least one of a said person(s) and said animal(s), electronic proxy attendant to at least one of a customer(s) in a commercial facility, customer(s) in a service facility, patient(s) in a health care facility, resident(s) in a retirement home, traveling party(s) in a transportation facility, visitor(s) to a house of worship, participant(s) in a non-secular activity, participant(s) in a secular activity, participant(s) in industrial facility, participant(s) visitor(s) to a governing body, a delivery person(s) in at least one of a political gathering, academic environment, business gathering, participant(s) in electronic media communication to the public, entertainment gathering, transportation customers, and at least one other person exposed to personification of at least one of a said another person(s) and said another animal(s).

10. A system for delivering an electronic proxy of at least one of a person, animal, botanic plant, and non-animate material for perceiving by at least one body sense(s) of at least one of a at least one individual(s) and at least one animal(s).

11. The system in accordance with claim 10, wherein said electronic proxy produces at least one of a text, sound, voice, speech, tonality, music, speech, singing, sigh, cough, laugh, cry, at least one of audible inhaling and exhaling, movements of at least one of an at least one limb(s), at least one facial muscle(s), forehead muscles, eyebrow muscles, lips, teeth configuration, letting moisture become visible in at least one of a within and around eyes area, and at least one of a closing and opening at least one eye(s).

12. The system in accordance with claim 10 wherein said electronic proxy comprises at least one of a single unit and parsing at least two units creating a seamless appearance of at least one of a visual, audio, and expressive thought presentation, wherein said unit is at least one of a physical body part, a part of said physical body part, a tone, part of a segment making up said tone, at least one word, a sentence, a segment of laugh, a segment o crying, a segment of a sigh, a limb, a part of a limb, motion of a limb, part of a motion of a limb, an eye stare, an expressed thought, a part of said expressed thought, any part of what a human presents in communication or presentation, a bark, a whimper and a part of a bark, a growl, and a part of a growl.

13. The system in accordance with claim 12 wherein said at least one of a single unit and parsing of said units is taken from a database containing said at least one of a single unit and several combined units representing at least one of a human and animal appearance, vocal expression, and thoughts for segmentation and parsing.

14. The system in accordance with claim 13 wherein said database(s) is constructed from at least one of a present and past living of at least one of a at least one individual(s) and at least one animal(s).

15. The system in accordance with claim 10 wherein said at least one of a appearance, vocal delivery, and at least one thought(s) by said electronic proxy is based on analyzing of at least one of a data available in said database(s), and by collecting information from at least one of a appearance, vocal expression, behavior, and expressing of at least one thought(s) by the contemporaneous exposition of the at least one person (s) and at least one animal(s).

16. The system in accordance with claim 12, wherein the electronic proxy system analyzes the presentation of at least one of a at least one individual(s) and at least one animal(s) in its presence to determine the situation, comprising collecting information from at least one of a appearance vocal expression, motion, at least one thought(s), questions asked and other pertinent information enabling a program utility to utilize the at least one appropriate database(s) enabling at least one of a analysis and the creation of at least one suitable response(s) befitting said situation.

17. The system according to claim 12 wherein said electronic proxy provides exposition generated from at least one database(s) containing material specifically related to said at least one of a individual(s) and animal(s) whose at least one of a personality attributes, vocal expression, appearance, at least one thought(s) is composed from material parsed from said at least one database(s).

18. The system in accordance with claim 12, wherein said electronic proxy exposition to another party comprising at least one of a text, vocal expression, appearance in at least one of a space, screen, video, Skyp, mobile unit and holographic materialization, wherein Said presented text, vocal expression(s), appearance(s), and thoughts expressed comprise at least one of a vocal expression, appearance, mannerism, and thought(s) represent a facsimile of said at least one another person(s) and another animal(s), clothing befitting at least one of personality traits of said person(s).
